(19) United States
(12) Patent Application Publication
(10) Pub. No.: US 2025/0272594 A1
(43) Pub. Date: Aug. 28, 2025

(54) QUANTUM SOURCE CODE GENERATION BASED ON A MODELING SYSTEM

(71) Applicant: INTERNATIONAL BUSINESS MACHINES CORPORATION, ARMONK, NY (US)

(72) Inventors: Juan Cruz Benito, Salamanca (ES); Iván Durán Martínez, Vigo (ES); Francisco Jose Martin Fernandez, Ridgefield, CT (US); Ismael Faro Sertage, CHAPPAQUA, NY (US)

(21) Appl. No.: 18/588,554

(22) Filed: Feb. 27, 2024

(51) Int. Cl. G06N 10/80; G06F 8/30

(52) U.S. Cl. CPC G06N 10/80; G06F 8/311

(57) ABSTRACT

An approach for assisting in the generation of quantum source code. The approach may include receiving a quantum source code input with a specification of constraints of a quantum unit on which the quantum source code input is to be run, wherein the constraints include available quantum qubits or gates and/or available quantum parameters. The method creates a variation of the quantum source code input by analyzing the quantum source code input against trained models, wherein the variation includes adjustment of the quantum unit constraints depending on the specification of constraints the quantum unit. The method provides a recommendation based on the variation to assist in quantum source code generation.

### Statement Regarding Prior Disclosures by the Inventor or a Joint INVENTOR (if applicable)

The following disclosure(s) are submitted under 35 U.S.C. 102 (b)(1)(A):

DISCLOSURE(S): IBM RESEARCH, “Software Turbocharging Quantum System Performance”, YouTube, Dec. 5, 2023, Downloaded from the Internet on Feb. 8, 2024, 8 pgs.,<https://www.youtube.com/watch?v=S4S9um5sBxM>.

### BACKGROUND

The present invention relates to quantum source code generation, and more specifically, to quantum source code generation using a modeling system.

A quantum computer is a computer which exploits quantum mechanical phenomena to address. At small scales, physical matter exhibits properties of both particles and waves, and quantum computing leverages this behavior using specialized hardware.

The basic unit of information in quantum computing is the “qubit”. A qubit exists in a superposition of its two “basis” states prior to a measurement. The result of measuring a qubit results in a probability of the state of the qubit. A quantum computer can manipulate a qubit to cause wave interference effects which can amplify the desired measurement results. The design of quantum algorithms involves creating procedures allowing a quantum computer to perform calculations efficiently.

Quantum programming is the process of assembling sequences of instructions, this sequence of instructions is called quantum circuits. Quantum circuits executed on a quantum computer. Quantum programming languages help express quantum algorithms with high-level constructs. Quantum instruction sets are used to turn higher level algorithms into physical instructions that can be executed on quantum processors. Sometimes these instructions are specific to a given hardware platform, e.g. ion traps or superconducting qubits.

Quantum software development kits (SDKs) provide collections of tools to create and manipulate quantum programs. SDKs also provide the means to simulate the quantum programs or prepare them to be run using cloud-based quantum devices or self-hosted quantum devices.

### SUMMARY

According to an embodiment of the present invention there is provided a computer-implemented method for assisting quantum source code generation, said method comprising: receiving a quantum source code input with a specification of constraints of a quantum unit on which the quantum source code input is to be run, wherein the constraints include available quantum qubits or gates and/or available quantum parameters; creating a variation of the quantum source code input by analyzing the quantum source code input against trained models, wherein the variation includes adjustment of the quantum unit constraints depending on the specification of constraints the quantum unit; and providing a recommendation based on the variation to assist in quantum source code generation.

The described method and system provide tailored source code variations to be more performant when running on specific quantum units. This works with any quantum computing programming language.

According to another embodiment of the present invention there is provided a computer-implemented method for training a modeling system for assisting quantum source code generation, said method comprising: inputting original quantum source code and custom variations of the original quantum source code; applying different quantum unit specification constraints as information for the training; and training the modeling system to provide a recommended variation of a quantum source code input.

According to a further embodiment of the present invention there is provided a system for assisting quantum source code generation, comprising: a processor and a memory configured to provide computer program instructions to the processor to execute the function of the components: an input receiving component for receiving a quantum source code input with a specification of constraints of a quantum unit on which the quantum source code input is to be run, wherein the constraints include available quantum qubits or gates and/or available quantum parameters; a variation generating component for creating a variation of the quantum source code input by analyzing the quantum source code input against trained models, wherein the variation includes adjustment of the quantum unit constraints depending on the specification of constraints the quantum unit; and a recommendation component for providing a recommendation based on the variation to assist in quantum source code generation.

According to a further embodiment of the present invention there is provided a training system for a modeling system for assisting quantum source code generation, the training system including: a training inputs component for inputting original quantum source code and custom variations of the original quantum source code; a quantum unit specification component for applying different quantum unit specification constraints as information for the training; and a training component for training the modeling system to provide a recommended variation of a quantum source code input.

According to a further embodiment of the present invention there is provided a computer program product for assisting quantum source code generation, the computer program product comprising a computer readable storage medium having program instructions embodied therewith, the program instructions executable by a processor to cause the processor to: receive a quantum source code input with a specification of constraints of a quantum unit on which the quantum source code input is to be run, wherein the constraints include available quantum qubits or gates and/or available quantum parameters; create a variation of the quantum source code input by analyzing the quantum source code input against trained models, wherein the variation includes adjustment of the quantum unit constraints depending on the specification of constraints the quantum unit; and provide a recommendation based on the variation to assist in quantum source code generation.

According to a further embodiment of the present invention there is provided a computer program product for training a modeling system for assisting quantum source code generation, the computer program product comprising a computer readable storage medium having program instructions embodied therewith, the program instructions executable by a processor to cause the processor to: input original quantum source code and custom variations of the original quantum source code; apply different quantum unit specification constraints as information for the training; and train the modeling system to provide a recommended variation of a quantum source code input.

The computer readable storage medium may be a non-transitory computer readable storage medium, and the computer readable program code may be executable by a processing circuit.

### BRIEF DESCRIPTION OF THE DRAWINGS

Embodiments of the present invention will now be described, by way of example only, with reference to the accompanying drawings.

FIG. 1 is a flow chart for a method of training a modeling system for the generation of quantum source code in accordance an embodiment the invention.

FIG. 2 is a flow chart of a method for the generation of quantum source code in accordance with an embodiment of the invention.

FIG. 3 is a block diagram of an example embodiment of a system in accordance with embodiments of the present invention;

FIG. 4 is a block diagram of an example embodiment of a system for training a modeling system for assisting generation of quantum source code in accordance with embodiments of the present invention;

FIG. 5 is a block diagram of an example embodiment of a system for training a modeling system for assisting generation of quantum source code in accordance with embodiments of the present invention; and

FIG. 6 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for assisting quantum source code generation using a trained modeling system.

Embodiments use models trained on quantum source code including language models and other machine learning methods to assist users writing quantum programs. The assistance in quantum code generation is an improvement in the technical field of computer program generation and testing.

Embodiments may include training a modeling system to assist in quantum source code generation. The modeling system is trained by inputting original quantum source code and custom variations of the original quantum source code while applying constraints (e.g., quantum unit specifications) for the training. This trains the modeling system to provide recommended variations of an input source code. The modeling system may include a language model compose quantum source code, identify the differences between the versions of quantum source code, and recognize when to propose variations in the quantum source code to enhance it. The modeling system may also include machine learning for adapting a quantum source code based on a quantum unit's specification configuration.

Embodiments may also include assisting a user to generate quantum source code with the trained modeling system. This may include receiving quantum source code as input along with the specification of a quantum unit's, which the quantum source code input is to be run. Further, analyzing the quantum source code input against trained models of the modeling system and creating a variation of the quantum source code. The variation of quantum source code may differ depending on the specification of the quantum unit (e.g., available quantum qubits or gates and available quantum parameters).

The following definitions are provided.

A “quantum computer” is a device capable of executing coherent controlled quantum dynamics. A “qubit” (short for quantum bit) is the basic unit of quantum information. A qubit consists of two-levels that can be expressed using the “computational basis” states and, unlike a classical bit, the state of a qubit can be a linear combination (superposition) of both computational states.

The term “backend” can refer to either a quantum system or a high-performance classical simulator of a quantum system. A “quantum unit” may be a quantum device, a quantum simulator, or a part of the hardware or software composing or related to a quantum device.

A “quantum program” is a piece of source code written in any language, specification, markup language, etc., expressing instructions to run in a unit with quantum capabilities.

A language model (LM) is defined as a probability distribution over sequences of words. Given such a sequence, say of length m, it assigns a probability P (w1, . . . , wm) to the whole sequence. This estimation of the likelihood of different sentences and sets of words is useful in many natural language processing applications.

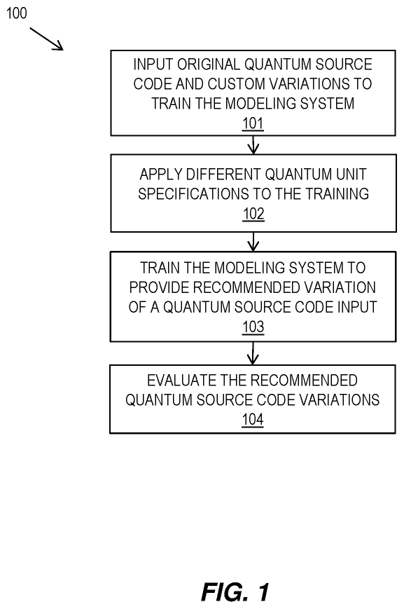

Referring to FIG. 1, a flow diagram 100 is a method for training a modeling system for assisting quantum source code generation, according to an embodiment of the invention.

At step 101, input an original quantum source code and/or custom variations of the original quantum source code into the modeling system.

At step 102 apply different quantum unit specification constraints as information for the training. Step 101 and 102 can occur simultaneously. In an embodiment, original source code and custom variations can be used to train the language models. The original source code may be high-level abstractions, quantum assembly level, or pulse-level programming. The custom source code variations may include errors, performance improvements, quality enhancements, the constraints and configuration of the different available quantum devices, etc.

The quantum unit specification constraints may be a backend configuration of static information of the quantum unit, backend defaults defining a basic current configuration of the backend of a quantum unit, and/or backend properties defining optimized gates, coupling maps, and/or qubits of the backend of a quantum unit.

At step 103, train the modeling system to provide a recommended variation of a quantum source code input. For example, embodiments may include training a language model to compose or generate quantum source code. Further the language model may identify the differences between versions of the quantum source code, and determine when to propose enhancement variations to the quantum source code.

An embodiment may include training a machine learning model associated with the modeling system to adapt a quantum source code based on a quantum unit's specification configuration.

At step 104, evaluate the recommended quantum source code variations of the modeling system. For example, executing automatic processes of evaluation against quantum units to check whether the code functionality and performance are enhanced. This may also include running an automatic code analysis to evaluate when the quantum source code syntaxis, style, or security is improved with a recommended variation.

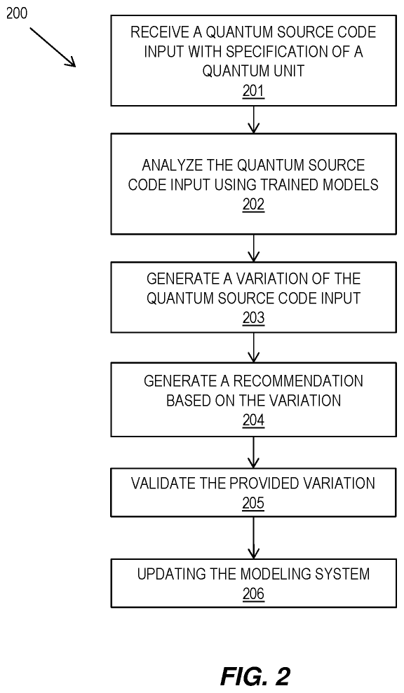

FIG. 2 is flow diagram 200, depicting a method for assisting quantum source code generation, according to an embodiment of the invention.

At step 201, receive a quantum source code input with a specification of constraints of a quantum unit on which the quantum source code input is to be run. The constraints may include the backend capabilities and backend properties of the quantum unit. The specification of constraints may include available quantum qubits or gates and/or available quantum parameters. The quantum parameters may be configuration, properties, and defaults of available quantum qubits or gates. Constraints may include for example, available backend gates, the backend topology or the qubits connectivity layout, the gate performance, error rates, measurement-related information, etc. The backend constraints are independent of the quantum programming languages and the quantum programming languages allow users to develop code that is aware of backend properties, constraints, or configurations.

The specification of constraints may be provided by the input source code. This may include information regarding which backend will be used to run the code. Alternatively, the input source code may include a specific configuration of gates, qubits, etc. within the programming context.

At step 202, analyze the quantum source code input against trained models and depending on the specification of the constraints of a quantum unit on which the code is to be run. For example, analyzing the quantum source against trained models may include using a language model to generate a variation with the language model trained on datasets that contain custom variations utilizing quantum computing static features. Analyzing against trained models may include using a language model trained on different datasets for different types of quantum units or users.

In an embodiment, analyzing against trained models may also include adapting source code utilizing one or more machine learning models, where the machine learning models consider which qubits or gates to use for the quantum unit specification.

At step 203, generate one or more variations of the quantum source code input. The variations may include adaptations, modifications, or adjustments of the quantum unit constraints on which the source code is run.

In an embodiment, if an input source code includes information regarding which backend is used to run the code, the variation may propose changes in the gates, qubits used, or other quantum features used in the quantum source code considering the quantum unit's specification. If an input source code contains a specific configuration of gates, qubits, etc., the variation may propose changes to the quantum source code including using another quantum unit for the execution of the quantum source code.

At step 204, generate a recommendation to assist in quantum source code generation, based on the variation. In an embodiment, the recommendation may propose one or more adaptations for the source code. The adaptations or modification may involve improvements to performance and quality for the specific quantum unit, as specified in the input.

In an embodiment, the variation may include adjusting the quantum source code in real-time depending on the real-time behavior of the quantum unit. The variation may include modifying backend properties of the quantum unit that can be modified at any time. The variation of the quantum source code can be based on the non-deterministic quantum behavior with multiple different variations based on a same input.

The quantum source code input may be one of: a high-level abstraction, quantum assembly level programming, and pulse-level programming. The variation may include one or more of: error or syntax corrections, performance improvements, quality enhancements, constraints and configuration of available quantum units.

At step 205, validate the variation. For example, execute the generated source code variation via a quantum unit and determine if the variation is an improvement on the original input quantum source code.

At step 206, if the generated variation source code is an improvement on the original input, update the modeling system based on the improvement. For example, the update can be based on reinforcement learning.

The following examples of a quantum unit's constraints are provided as exposed in Qiskit® (Qiskit is a trademark of International Business Machines Corporation). Qiskit is an Open Source software development kit developed by IBM® (IBM is a trademark of International Business Machines Corporation). Quantum circuits are created and manipulated using Python® (Python is a trademark of Python Software Foundation). Results are obtained either using simulators that run on the user's own device, simulators provided by IBM or prototype quantum devices provided by IBM. As well as the ability to create programs using basic quantum operations, higher level tools for algorithms and benchmarking are available within specialized packages. Qiskit is based on the OpenQASM standard for representing quantum circuits. The use of Qiskit is provided as an example and the described method and system is applicable to any quantum programming language and may be applied in any quantum programming SDK.

Among the different quantum unit constraints included as information for the training, the following may be used.

Backend configuration: This is the static information of the quantum unit. This includes information such as: backend_name, backend_version, n_qubits, basis_gates, dt, meas_levels, dtm, meas_map, or any other current or future basic configuration. These terms refer to the name of the backend, the version, the number of qubits employed in the backend, the gates allowed in the backend, the measurement levels, the measurement map, etc.

Backend defaults: These define the basic current configuration of the backend. It includes information fields such as: qubit_freq_est, meas_freq_est, buffer, pulse_library, cmd_def, meas_kernel, discriminator, _data, or any other future information related. These terms refer to the estimated frequency of the qubits, the estimated frequency for the measurement, the backend's buffer to store information, whether the backend allows programming using pulses directly, the command definition, the kernel measurements, the discriminator, etc.

Backend properties. These define the backend's performance properties including which gates perform better, what are the coupling maps, or which qubits are better to use. Some fields included in this information: gates, general, qubits. It also may contain more information in the future.

The described methods and systems provide the following features.

The user's quantum source code may contain the quantum unit's specification to run the code. Alternatively, the quantum unit's specification may be included in the programming context. As the quantum unit's specification is included, the modeling system can propose adaptations for the source code in the provided variation of the source code to improve performance and quality for that specific quantum unit. To do so, the modeling system uses what it learnt from the quantum constraints included in the training data.

To improve the training, automatic processes of evaluating the fixes and improvements proposed by the modeling system are tested against quantum units to check whether the code functionality and performance are enhanced or not. The modeling system is reinforced with the feedback from these tests.

Automatic code analysis may also be carried out to evaluate if the code syntaxis, style, or security is improved with the changes proposed by the system. The results from these checks are used to give feedback to the modeling system.

At the usage (inference) time of the system, based on a text input of the quantum program source code, the method and system return the source code with the modeling system's changes in the form of a variation of the input source code. The user may decide whether or not to change their code.

The following provide some examples of how the proposed quantum source code generating assistant may aid a user.

Regarding the enhancement of a quantum program's performance and quality, the following may be included.

When the user's source code input includes the information about which backend will be used to run the code, the assistant may propose changes in the gates, qubits used, or other quantum features used in the code to increase the performance considering the backend's configuration, properties, and defaults.

When the user's source code input contains a specific configuration of gates, qubits, etc., the assistant may propose changes in the code to use another quantum unit for the execution. This may occur if the assistant finds another better quantum unit for the user's code.

Regarding the automatic seeking and remediation of security issues, the following may be included.

Knowing the source code input from the user's program, the backend's internal configuration, and the potential results of executing code in the backend, the assistant may help the users to re-write programs that will raise a timeout in the backend. This will help users to avoid spend time running wrong code and can help the quantum platform/software stack to mitigate potential denial-of-service (DDOS) attacks on the backends.

The assistant may also help the user with static code recommendations based on inspection of libraries to use, static code analysis, and other “classic” approaches to assist programmers.

In the described method and system, custom variations are introduced in the training datasets to take advantage of certain quantum computer static features (backend's configuration: * backend_name*, *backend_version*, *n_qubits*, *basis_gates*, etc.).

The language models are also trained on different datasets depending on different noise mitigation techniques that work better for specific devices or that are better for different types of users (for example, researchers vs. regular developers).

Recommendations from the language models that include specific code to run in particular devices can pass a second step in which backend properties that can be modified at any time are injected. Some examples are related to backend defaults like *qubit_freq_est*, *meas_freq_est*, *buffer*, *pulse_library*, *cmd_def*, *meas_kernel*, *discriminator*, or much more essential features that change several times per day like the backend's performance gates, which qubits are better to use in the moment of the recommendation, etc.

Related to this, other machine learning methods apart from language models may be used to compute the qubits and gates information coming from the quantum devices API and adapt the code based on machine learning-powered decisions on which qubits or gates to use. For example, machine learning may be used to predict values of real-time noise, performance, etc. that will result from the circuits used in the code when combining multiple qubits or gates.

A code recommendation from the language model may include a recommendation related to a specific device, and the recommendation may be adjusted in real time based on the behavior of the real quantum computer at the time of suggestion and without relying only on static training datasets.

As the method is connected to real quantum units, the recommendations may be validated. In parallel to any recommendation produced by the modeling system of the language model and related machine learning models, the recommendation may be submitted with the code variation and the original code from users to any quantum unit (quantum simulator, quantum computer, or any specific part of those) to check the quality of the recommendation.

Some potential checks, depending on the proposed modifications, are as follows. If the results from the checks are positive, the code variation may be included in the training datasets (if it did not exist previously) to improve them. 1.) That the code variation produces the same result as the original one. This may be appropriate if the code variation is related to style, or minor improvements. 2.) That the code variation runs correctly. This may be appropriate if the code variation fixes any error. 3.) That the code variation produces a better result. This may be appropriate if the code variation is related to improving quality of the code for any backend. 4.) That the code variation performs better than the original code. This may be appropriate if the code variation is related to performance in any quantum backend.

Different outputs of the code variations are generated compared to classical computing. For example, some quantum algorithms involve using services like Near Time Quantum Computing. In this environment, algorithms like the Variational Quantum Eigensolver (VQE) are used. These algorithms consist of iterating the same code with different quantum parameters to obtain different solutions over time.

Classical algorithms are based on obtaining a fixed set of outputs with the same input and they are not designed to work correctly with this kind of algorithm that varies the result iteratively based on previous executions of a non-determinist iterative algorithm like VQE.

Therefore, a difference of the described method and system is that considering the same input, the described method and system can return different outputs based on this non-deterministic quantum behavior. This means that the method and system can suggest different variations for the outputs based on the same input due to the quantum nature of the system and can also adjust these outputs based on previous experience and data using a particular quantum backend.

The following examples, show use quantum source code input and a suggestion of variation of source code input as provided by the described system with the difference of the variation shown in underline:

### Example 1

User quantum source code input:
from qiskit import *
   qc=QuantumCircuit(2,2)
   qc.h(0)
   circ.cx(0, 1)
   circ.cx(0, 2)
   circ.measure(range(2), range(2))

Suggestion of variation of source code input provided by the system shown in underline:
from qiskit import *
   qc=QuantumCircuit(2,2)
   qc.h(0)
   circ.cx(0, 1)
   circ.cx(0, 2)
   circ.measure(range(2), range(2))
   backend=QasmSimulator( )
   job=backend.execute(qc,backend)
   result=job.result( )

### Example 2

User quantum source code input:
from qiskit import *
   qc=QuantumCircuit (2,2)
   qc.h(0)
   circ.cx(0, 1)
   circ.cx(0, 2)
   circ.meas(range(3), range(2))

Suggestion of variation of source code input provided by the system shown in underline:
from qiskit import *
   qc=QuantumCircuit(2,2)
   qc.h(0)
   circ.cx(0, 1)
   circ.cx(0, 2)
   circ.measure(range(2), range(2))

### Example 3

User quantum source code input:
from qiskit import *
   realBackend= . . .
   cr=ClassicalRegister(2)
   bell=QuantumCircuit(qr, cr)
   bell.h(qr [2])
   bell.cx(qr [2], qr [4])
   bell.measure(qr [2],cr [0])
   bell.measure(qr [4],cr [1])
   job=qiskit.execute([bell], backend=realBackend,
      shots=5000, noise_model=noise_model)
   results=job.result( )
   raw_counts=results.get_counts( )

Suggestion to complete code with error mitigation on a specific quantum device by the described system with changes shown in underline.
from qiskit import *
   realBackend=
   cr=ClassicalRegister(2)
   bell=QuantumCircuit(qr, cr)
   bell.h(qr [2])
   bell.cx(qr [2], qr [4])
   bell.measure(qr [2],cr [0])
   bell.measure(qr [4],cr [1])
   job=qiskit.execute([bell], backend=realBackend,
      shots=5000, noise_model=noise_model)
   results=job.result( )
   raw_counts=results.get_counts( )
   meas_fitter=CompleteMeasFitter(results, state_labels,
      circlabel=‘mcal’)
   meas_fitter_sub=meas_fitter.subset_fitter(qubit_sublist=[2.4])
   meas_filter_sub=meas_fitter_sub.filter
   mitigated_results=meas_filter_sub.apply(results)
   mitigated_counts=mitigated_results.get_counts(0)

Including the described method and system in computational tools such as programming assistants may automatically avoid adverse situations by checking, fixing, and improving the code.

Incorporating the described system into a programming assistant tool may assist users' experience when using a quantum computing platform, IDE to write quantum code, or quantum languages and libraries and may help users upgrade their performance whilst coding. This provides a better programming experience for the users by helping write better quantum programs. This also helps new quantum programmers by using this solution while learning to code using any current or future quantum software.

By integrating the described system into a quantum platform, automatic code improvements may be introduced in other parts of the system that improve the code used in the system's sub-parts. This may also mitigate errors in code and increase its quality.

By applying this method, the knowledge about what kind of errors are commonly experienced by programmers is increased and that knowledge may be applied in future products, educational resources, etc.

Some of the potential benefits that may be provided to users include: adapting their code to specific quantum computers; correcting typos; automatically enhancing the syntax of the code or suggesting to users new code based on their inputs; improving the functionality of the code written by users to enhance the quality of the code (and the subsequent circuits); and scaling up its performance.

Using a machine learning-based assistant, errors, quality issues, and performance bottlenecks can be identified and proposals provided for fixes for them.

The described method and system may be integrated with existing products such as quantum programming IDEs, online resources, etc. by exposing the modeling system including language models via an API to provide Software as a Service (Saas).

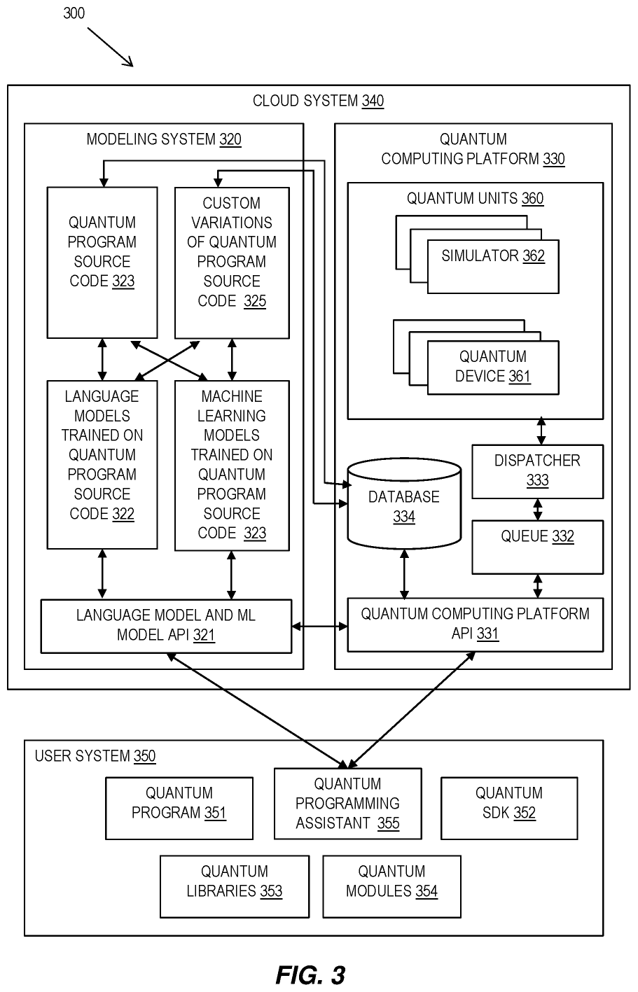

Referring to FIG. 3, a block diagram shows an example embodiment of a system 300 implementing the described method and system. The system 300 may include a cloud system 340 including a modelling system 320 and a quantum computing platform 330.

The system may also include a user system 350 at which a user may interact with the modelling system 320 and quantum computing platform 330. The user system 350 may include known quantum programming tools including a quantum software development kit 352 with quantum libraries 353 and quantum modules 354 for generating a quantum program 351. The described method and system provide a quantum programming assistant 355 for receiving a quantum source code input from the user and for providing recommendations generated by the modeling system 320 including variations of the quantum source code input. The recommendations are generated based on a specification of a quantum unit 360 of the quantum computing program 330 on which the quantum program 351 is to be run. Quantum units 320 may include simulators 362 or quantum devices 361.

The quantum computing platform 330 may include quantum units 320 including simulators 362 and/or quantum devices 361. A quantum computing platform application programming interface (API) 331 provides an interface for the quantum programming assistant 355 of the user system 350. Inputs to the quantum computing platform 330 from the quantum programming assistant 355 may be sent to a queue 332 to a dispatcher 333 for running on the quantum units 360. The quantum computing platform 330 may include a database 334 for storing outputs of the modeling system 320.

The modelling system 320 may include a language model 322 trained on quantum program source code and machine learning models 323 trained on quantum program source code 323. The modelling system 320 includes a language model and machine learning model API 321 for interfacing with the quantum programming assistant 355 of the user system 350. The modeling system 320 is trained using quantum program source code 323 and custom variations of the quantum program source code 325.

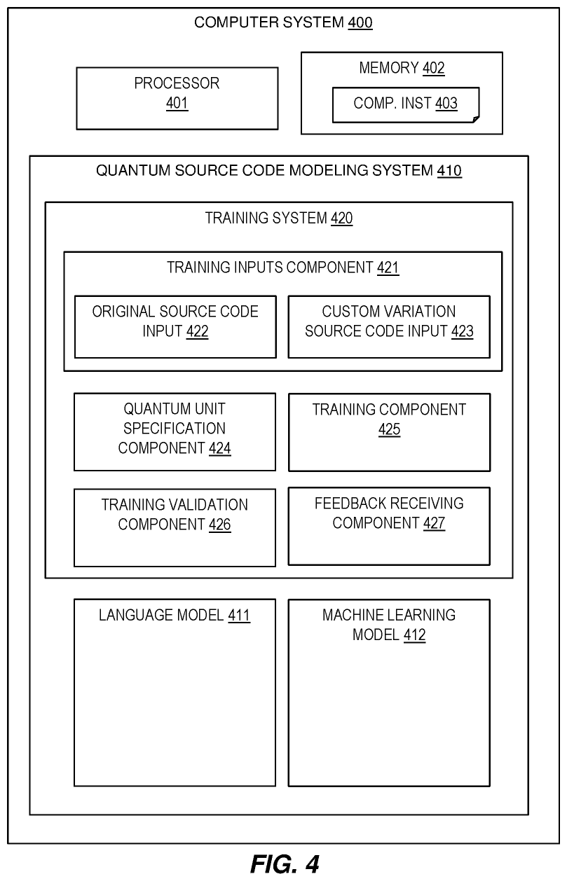

Referring to FIG. 4, a block diagram shows an example embodiment of a computer system 400 on which a quantum source code modeling system 410 is provided.

The computer system 400 includes at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

The quantum source code modeling system 410 may include a language model 411 and a machine learning model 412. The quantum source code modeling system 410 may include a training system 420 for training the models 411, 412.

The training system 420 may include a training inputs component 421 for inputting original quantum source code 422 and custom variations 423 of the original quantum source code. The training system 420 may include a quantum unit specification component 424 for applying different quantum unit specification constraints as information for the training. The training system 420 may include a training component 425 for training the models 411, 412 to provide a recommended variation of a quantum source code input including variation of the quantum unit constraints.

The training system 420 may also include a training validation component 426 for validating variations produced by the modeling system 410 by submitting a quantum source code input and a variation to a quantum unit having the specification and evaluating the outcomes. The training system 420 may include a feedback receiving component 427 for receiving feedback of a quantum source code input and recommended variation to the training system.

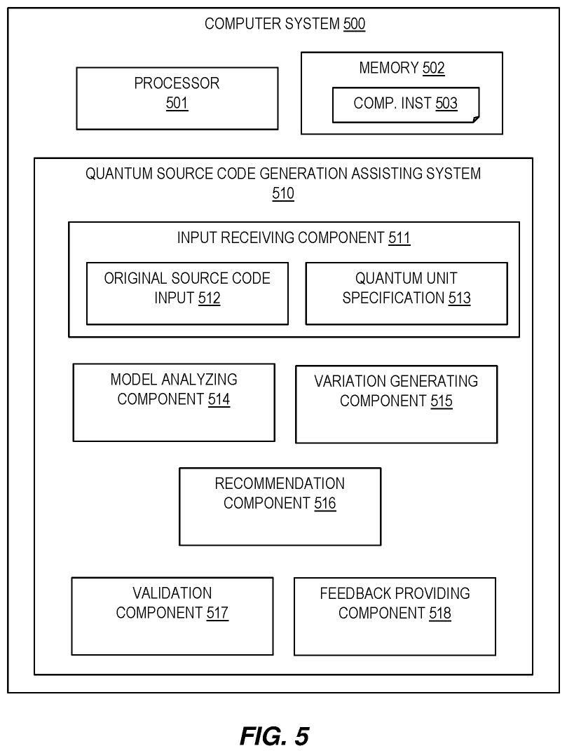

Referring to FIG. 5, a block diagram shows an example embodiment of a computer system 500 on which a quantum source code generation assisting system 510 is provided.

The computer system 500 includes at least one processor 501, a hardware module, or a circuit for executing the functions of the described components which may be software units executing on the at least one processor. Multiple processors running parallel processing threads may be provided enabling parallel processing of some or all of the functions of the components. Memory 502 may be configured to provide computer instructions 503 to the at least one processor 501 to carry out the functionality of the components.

The quantum source code generation assisting system 510 may include an input receiving component 511 for receiving a quantum source code input 512 with a specification 513 of constraints of a quantum unit on which the quantum source code input is to be run. The constraints may include available quantum qubits or gates in the quantum unit and available quantum parameters of the quantum unit.

The quantum source code generation assisting system 510 may include a model analyzing component 514 for submitting the inputs to a modeling system and a variation generating component 515 for creating a variation of the quantum source code input with the variation adjusted depending on the specification of the quantum unit.

The quantum source code generation assisting system 510 may include a recommendation component 516 for providing a recommendation based on the variation to assist in quantum source code generation.

The quantum source code generation assisting system 510 may include a validation component 517 for validating a variation by submitting a quantum source code input and a variation to a quantum unit having the specification and evaluating the outcomes.

The quantum source code generation assisting system 510 may include a feedback providing component 518 for providing feedback of a quantum source code input and recommended variation to the training system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

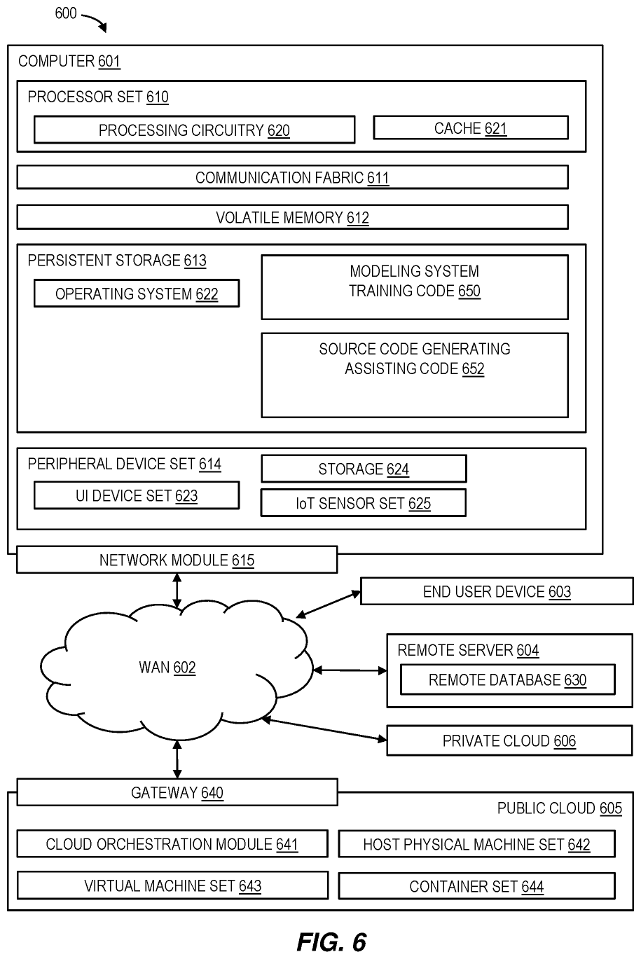

Referring to FIG. 6, computing environment 600 contains an example of an environment for the execution of at least some of the computer code involved in performing the inventive methods, such as the modeling system training code 650 and the source code generating assisting code 652. In addition to modeling system training code 650 and source code generating assisting code 652, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and modeling system training code 650 and source code generating assisting code 652, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in modeling system training code 650 and source code generating assisting code 652 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in modeling system training code 650 and source code generating assisting code 652 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for quantum source code generation, said method comprising:
receiving a quantum source code input with a specification of constraints of a quantum unit on which the quantum source code input is to be run, wherein the constraints consist of one or more of the following: available quantum qubits, gates and available quantum parameters;
creating a variation of the quantum source code input by analyzing the quantum source code input against trained models, wherein the variation includes adjustment of the quantum unit constraints depending on the specification of constraints the quantum unit; and
providing a recommendation based on the variation to assist in quantum source code generation.

2. The computer-implemented method of claim 1, wherein analyzing against trained models includes using a language model to generate a variation with the language model trained on datasets that contain custom variations utilizing quantum computing static features.

3. The computer-implemented method of claim 1, wherein analyzing against trained models includes using a language model trained on different datasets for different types of quantum units or users.

4. The computer-implemented method of claim 1, wherein analyzing against trained models includes using machine learning to adapt source code based on machine learning decisions on which qubits or gates to use and/or the quantum parameters for the quantum unit specification.

5. The computer-implemented method of claim 1, wherein the variation includes adjusting the quantum source code in real time depending on a real time behavior of the quantum unit.

6. The computer-implemented method of claim 5, wherein the variation includes modifying backend properties of the quantum unit that can be modified at any time.

7. The computer-implemented method of claim 1, wherein the quantum source code input is one of the group of: a high-level abstraction, quantum assembly level programming, and pulse-level programming.

8. The computer-implemented method of claim 1, wherein the variation includes one or more of the group of: error or syntax corrections, performance improvements, quality enhancements, constraints, and configuration of available quantum units.

9. The computer-implemented method of claim 1, further comprising:
validating a variation by submitting the variation and the quantum source code input to a quantum unit having the specification and evaluating the outcomes.

10. The computer-implemented method of claim 9, wherein, when there is an improvement by the variation, including the variation in a training dataset for the trained models.

11. A computer-implemented method for training a modeling system for quantum source code generation, said method comprising:
inputting original quantum source code and custom variations of the original quantum source code;
applying different quantum unit specification constraints as information for the training; and
training the modeling system to provide a recommended variation of a quantum source code input.

12. The computer-implemented method of claim 11, further comprising:
training a language model in the modeling system to learn how quantum source code is composed, to learn the differences between the different versions of the quantum source code, and to learn to recognize when to propose variations in the quantum source code to enhance it.

13. The computer-implemented method of claim 11, further comprising:
training a machine learning model in the modeling system to adapt a quantum source code based on a configuration of a quantum unit's specification constraints.

14. The computer-implemented method of claim 11, further comprising:
running automatic processes of evaluating the recommended variations of the modeling system against quantum units to check whether the code functionality and performance are enhanced; and
providing feedback to the modeling system.

15. The computer-implemented method of claim 11, further comprising:
running automatic code analysis to evaluate when the quantum source code syntaxis, style, or security is improved with a recommended variation; and
providing feedback to the modeling system.

16. The computer-implemented method of claim 11, wherein the quantum unit constraints include one or more of the group of: a backend configuration of static information of the quantum unit; backend defaults defining a basic current configuration of the backend of a quantum unit; and backend properties defining optimized gates, coupling maps, and/or qubits of the backend of a quantum unit.

17. A computer system for quantum source code generation, the computer system comprising:
a processor;
a memory;
one or more computer program instructions stored on the memory, the computer program instructions executable by the processor to perform one or more operations, the operations comprising:
receive a quantum source code input with a specification of constraints of a quantum unit on which the quantum source code input is to be run, wherein the constraints consist of one or more of the following: available quantum qubits, gates and available quantum parameters;
create a variation of the quantum source code input by analyzing the quantum source code input against trained models, wherein the variation includes adjustment of the quantum unit constraints depending on the specification of constraints the quantum unit; and
provide a recommendation based on the variation to assist in quantum source code generation.

18. The computer system of claim 17, further comprising program instructions to:
input original quantum source code and custom variations of the original quantum source code;
apply different quantum unit specification constraints as information for the training; and
train the modeling system to provide a recommended variation of a quantum source code input.

19. The computer system of claim 17, further comprising program instructions to:
validate a variation by submitting the variation and the quantum source code input to a quantum unit having the specification and evaluating the outcomes.

20. The computer system of claim 18, further comprising program instructions to:
provide feedback of a quantum source code input and recommended variation to the training system.
